(19) United States
(12) Patent Application Publication
(10) Pub. No.: US 2022/0065779 A1
(43) Pub. Date: Mar. 3, 2022

(54) COMPACT IN-LINE NON-CONTACT OPTICAL PROPERTY MEASUREMENT SYSTEM

(71) Applicant: NDC Technologies Inc., Dayton, OH (US)

(72) Inventors: Wilhelm WAGNER, Kuchl (AT); Phillip Coleman JONES, Essex (GB)

(73) Assignee: NDC Technologies Inc., Dayton, OH (US)

(21) Appl. No.: 17/411,596

(22) Filed: Aug. 25, 2021

Related U.S. Application Data
(60) Provisional application No. 63/070,641, filed on Aug. 26, 2020.

(51) Int. Cl. G01N 21/47; G02B 26/00

(52) U.S. Cl. CPC G01N 21/4738; G01N 2021/4735; G02B 26/007

(57) ABSTRACT

Disclosed herein are compact, on line, real-time, non-contact optical property measurement systems and methods thereof capable of measuring optical quality such as haze, clarity, luminance of a film during the film manufacturing process. More specifically, the optical property measurement system can move in the transverse direction along the film while the film is on the line, thereby measuring the optical property of the film in real time at various locations on the film in both the transverse and machine direction.

### CROSS-REFERENCE TO RELATED APPLICATIONS

This application claims the priority of U.S. Provisional Application No. 63/070,641, filed Aug. 26, 2020, the entire contents of which is incorporated herein by reference.

### FIELD

This disclosure relates generally to an optical property measurement system. Specifically, this disclosure relates a compact, in-line, non-contact optical property measurement system.

### BACKGROUND

Appearance is an important property of plastic films used in packaging and labelling applications. For examples, appearance can be used to accentuate the appeal of products inside or behind the plastic film. Haze is an important parameter used to define cloudiness of a film caused by light scattering within the film structure and from the film's surfaces.

Haze can be measured according to ASTM D1003. The haze is commonly defined by the percentage of light transmission which deviates greater than 2.5 degrees. More specifically, haze is a measure of transmitted light scattered by a sample where the deviation of the light is greater than 2.5 degree angle from the incident light direction and this measure is compared with the total light transmitted by the sample and expressed as a percentage.

The most common arrangement on how to measure haze is defined by ASTM D1003 Method A. An example of how to measure haze according to ASTM D1003 Method A is shown in FIG. 1A. This arrangement includes collimated incident illumination combined with a detection system that includes an integrated sphere geometry to detect total transmittance (all transmitted light) and diffuse transmittance (deviation >2.5 degrees) in turn by opening and closing an exit aperture of the detection sphere to include or exclude the light that is inside the 2.5 degree angle. Specifically, a collimated beam of light from a light source passes through a sample/specimen that is mounted at an entrance port of an integrating sphere. The light, which is uniformly distributed by a matte white highly reflective coating on the sphere walls, is measured by a receptor (i.e., photodetector) positioned perpendicular to the collimated beam (i.e., 90° from the entrance port). An exit port/aperture immediately opposite the entrance port includes a light trap (i.e., dark box) to absorb all light from the light source when no sample is present. A shutter (shown as white plate in FIG. 1A) in this exit port can be coated with the same coating as the sphere walls to allow the port to be opened and closed as required, wherein total transmittance is measured with the exit port closed and diffuse transmittance is measured with the exit port open.

A less common method of measuring haze is ASTM D1003 Method B. An example of how to measure haze according to ASTM D1003 Method B is shown in FIG. 1B. Method B utilizes an integrating sphere to illuminate the sample mounted at an exit aperture of the sphere and detects light transmitted by the sample that is confined only inside the 2.5 degree angle. The detector subtends at the sphere exit port. To provide a measure of diffuse transmittance, this sphere has a second exit aperture to ensure that no light directly emitted from the sphere falls within this 2.5 degree detector acceptance angle. To measure the total transmittance, the second aperture is filled with a light trap (i.e., white standard). Thus, a 2-stage measurement geometry is required to generate the full angle and annular diffuse illumination conditions on the sample in turn.

In both ASTM D1003 Method A and Method B, the sample is in physical contact (entrance port in Method A and exit port in Method B) with the integrating sphere. As such, the sample that is being measured for haze is in intimate contact with a hard surface of the measuring device. In both cases, the detection module compares the measure of light intensity as a result of scattered rays deviated by >2.5 degrees of the incident rays with the total light intensity from all rays passing through the sample.

### SUMMARY

As explained above, haze is a measurement of optical effects that influence appearance of a film. There are many sources of haze variations including: (1) surface roughness; (2) surface distribution of polymer crystallites (local refractive index or roughness variations); (3) volume distribution of polymer crystallites (local refractive index or roughness variations); (4) scatter due to partial molecular crystallinity, anisotropy, and alignments (local refractive index or roughness variations); (5) fillers; (6) additives; (7) coatings/multilayers; and/or (8) embossings. Some or all of these sources of haze variations can arise as a direct result of control actions used to control other properties of the film in the manufacturing process such as, but not limited to, thickness, barrier properties, strength and some vary due to temporary glitches in the process such as feedstock changes.

The haze of the film can be critical for various applications such as packaging film haze profile, optical film, anti-bloc and additives, and/or regrind and recycling scrap. Some films may have 5% change across the scan (i.e., Left-Center-Right) which can result from a chill roller or oven profile issues. It can be important to detect this as part of process diagnostics. As such, haze measurements can alert uses that something has changed in the process, such as the cooling of the cast film affecting the crystallization pre-stretch or too much regrind addition, etc.

For displays such as screen protectors, touchscreens, etc., there is a growing interest in Optical Film, where haze is typically <0.5%, ideally 0.2% with a thickness of 120-180 microns, but trending downwards toward 90 microns. An Optical Film line operating with a haze specification of <0.5% can require a haze measurement to be able to set up and control the Chill, MD, and TD stretch. Anti-block additives can melt to reduce film sticking together and form particles that stick out above the surface to reduce contact area and static but also contribute to haze in a manner that is characteristic of anti-block size. Anti-block particles can be a few microns to nanometers or anywhere in between. The haze of a film with anti-block particles can be dependent on polymer crystal spherulite sizes at the surface interfaces. Lastly, the addition of regrind into a melt mix feed at the extruder can have the desirable effect of reducing the amount of virgin stock material and scrap. However, regrind can add to haze so there is a desire to use a real time haze measurement to maximize the regrind fraction while keeping the haze profile within the desired specification.

There are many limitations to the haze measurement methods described in ASTM D1003. First, these off-line measurements require a sample to be cut from the end of a roll and presented to a lab haze meter (set up for Method A or B) and the data for the samples being used as representative of the whole roll as a pass/fail criterion. These rolls of films can take up to 4 hours or more to be manufactured and can be up to about 50000 m in length. As such, the test sample is only a representative of the haze at the fraction of a second at the end of the roll. Second, because the ASTM methods are contact methods, if the measurement was to be attempted in-line, where the films can be moving at speeds of several hundred m/min, the contact measurements are undesirable as the film surface can be damaged, thereby affecting the topical and appearance properties. Third, the ASTM measurements are slow (1-5 seconds/measurement) because of mechanically moving parts of the haze mater. Lastly, there are no windows in the optical path to prevent contamination.

Applicants have discovered a compact, in-line, non-contact optical property (e.g., haze, clarity, luminance) measurement system. Specifically, this system can provide real time scanning of the film during manufacturing that can show changes where and when they occur. This allows the user to take corrective actions. In addition, the systems disclosed herein can provide standoff distance for online measurement tolerating typical sheet flutter.

In some embodiments, an optical property measurement system includes a transmitter, the transmitter comprising: a diffuse reflector comprising a first aperture and a second aperture; a direct light source configured to direct light through the second aperture and first aperture toward a sample spaced apart from the first aperture at less than a predetermined amount of degrees around an illumination axis between the direct light source and a receiver, wherein the diffuse reflector comprises at least one light source adjacent the first aperture and configured to direct light at an inner surface of the diffuse reflector such that it is reflected out the first aperture towards the sample over a range of angles greater than or equal to the predetermined amount of degrees around the illumination axis; and the receiver configured to detect light from the direct light source and the at least one light source that is scattered by the sample to an angle of less than the predetermined amount of degrees around the illumination axis, wherein the system is configured to determine an optical property of the sample based on the scattered light detected from the at least one light source and the direct light source. In some embodiments, the diffuse reflector has a truncated spherical shape or a planar shape. In some embodiments, the predetermined amount of degrees is 2.5 degrees. In some embodiments, the transmitter is located on one side of the sample and the receiver is located on the other side of the sample. In some embodiments, the sample is a film, and the transmitter and the receiver are configured to move in unison across the transverse direction of the film. In some embodiments, the system includes a filter comprising at least one white reference reflector. In some embodiments, the filter is configured to cover the second aperture of the reflector with the at least one white reference reflector. In some embodiments, the system includes a motor configured to rotate the filter such that the at least one white reference reflector covers and uncovers the second aperture of the reflector. In some embodiments, the filter comprises a translucent white reference reflector. In some embodiments, the at least one light source comprise at least one of a white light source, a UV light source, a red light source, a green light source, a blue light source, and an infrared light source. In some embodiments, the sample is spaced apart from the first aperture by at least 5 mm.

In some embodiments, a method of measuring an optical property of a sample includes illuminating a sample via at least one light source, wherein the at least one light source is adjacent a first aperture of a diffuse reflector and configured to direct light at an inner surface of the diffuse reflector such that it is reflected out the first aperture towards the sample over a range of angles greater than or equal to a predetermined amount of degrees around an illumination axis between a direct light source and a receiver; detecting light from the at least one light source that is scattered by the sample to an angle of less than the predetermined amount of degrees around the illumination axis; illuminating a sample via the direct light source configured to direct light through a second aperture of the truncated spherical diffuse reflector and through the first aperture at less than the predetermined amount of degrees around the illumination axis; and detecting light from the direct light source that is scattered by the sample to an angle of less than the predetermined amount of degrees around the illumination axis; and determining an optical property of the sample based on the scattered light detected from the at least one light source and the direct light source, wherein the sample is spaced apart from the first aperture. In some embodiments, the method includes covering the second aperture with a filter comprising a white reference reflector. In some embodiments, the second aperture is covered by the filter, the at least one light source directs light at an inner surface of the diffuse reflector and the white reference reflector such that it is reflected out the first aperture towards the sample over a range of angles greater than or equal to 0 degrees around the illumination axis. In some embodiments, the diffuse reflector has a truncated spherical shape or a planar shape. In some embodiments, the predetermined amount of degrees is 2.5 degrees. In some embodiments, the transmitter is located above the sample and the receiver is located below the sample. In some embodiments, the sample is a film, and the transmitter and the receiver are configured to move in unison across the transverse direction of the film. In some embodiments, the at least one light source comprises at least one of a white light source, a UV light source, a red light source, a green light source, a blue light source, and a near infrared light source. In some embodiments, the sample is spaced apart from the first aperture by at least 5 mm.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE DRAWINGS

An exemplary embodiment of the present invention is illustrated by way of example in the accompanying drawings. The drawings show.

FIG. 1A is an example of a haze measurement system according to ASTM D1003 Method A.

FIG. 1B is an example of a haze measurement system according to ASTM D1003 Method B.

FIG. 2 is an example of an optical property measurement system disclosed herein in accordance with some embodiments.

FIG. 3 is an example of an optical property measurement system with windows disclosed herein in accordance with some embodiments.

FIG. 4A is an example of an optical property measurement system with a filter that includes a white reference reflector disclosed herein in accordance with some embodiments.

FIG. 4B is an example of a diffuse annular illumination condition of an optical property measurement system with a filter that includes a white reference reflector disclosed herein in accordance with some embodiments.

FIG. 4C is an example of a diffuse total illumination condition of an optical property measurement system with a filter that includes a white reference reflector disclosed herein in accordance with some embodiments.

FIG. 4D is an example of a direct near axis illumination condition of an optical property measurement system with a filter that includes a white reference reflector disclosed herein in accordance with some embodiments.

FIG. 5 is an example of an optical property measurement system with a filter that includes a translucent white reference reflector disclosed herein in accordance with some embodiments.

FIG. 6 is an example of an optical property measurement system wherein the plurality of light sources includes at least two different light sources comprising UV, red, green, blue, or NIR light sources disclosed herein in accordance with some embodiments.

FIG. 7 is an example of an optical property measurement system with a planar reflector containing a plurality of light sources that are edge coupled to the reflector disclosed herein in accordance with some embodiments.

FIG. 8 is an example of an optical property measurement system with a planar reflector containing a plurality of light sources that upward/downward emitting in the reflector disclosed herein in accordance with some embodiments.

FIG. 9 illustrates how total transmittance (Tₜ), sample diffusion rate (T₄), and scattering rate (T₃) are obtained using an integrating sphere.

FIG. 10 depicts a computer, in accordance with some embodiments.

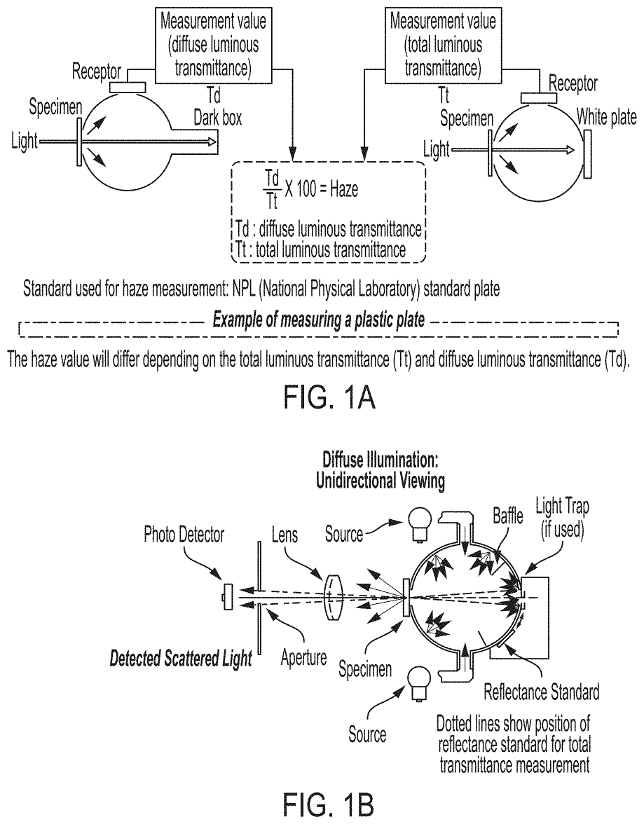

### DETAILED DESCRIPTION

Applicants have discovered a compact, online, real time non-contact optical property measurement system capable of measuring the optical properties (e.g., haze, clarity, luminance, etc.) of a film during the manufacturing process while the film is still on the line. Specifically, the optical property measurement system can move in the transverse direction across the film while the film is on the line, thereby measuring the optical property of the film in real time at various locations across the film both transversely and in the machine direction. Accordingly, the optical property of the film can be monitored in real time such that if the optical property drops below a specific threshold, the system can alert a user that changes to the film manufacturing process are required.

In addition, the optical property measurement system disclosed herein can have good standoff and tolerance to having the transmitting and receiving halves of the system separated and being mounted on a traversing frame across the wide sheet of the film. The systems disclosed herein can measure the degree of scatter from a film sample in real-time without contacting the film sample and can correspond with haze per ASTM D1003.

ASTMD1003 methods A and B both define the measurement geometry from the perspective of an integration sphere (Method A with a sphere on the detection side and Method B with a sphere on the illumination side). The first aperture of the sphere in each method can define the sampling area in both methods. The near axis angular light from the diffuse light source can be suppressed by the diffuse light source second aperture. By combining the angularly annular wide area illumination with narrow angle receiver optics, the systems disclosed herein can both rejects the undeviated/low angle scattered light as required for a Haze measurement and reject the spatial areas outside the central measurements zone where the illumination conditions are not as required for the Haze measurement.

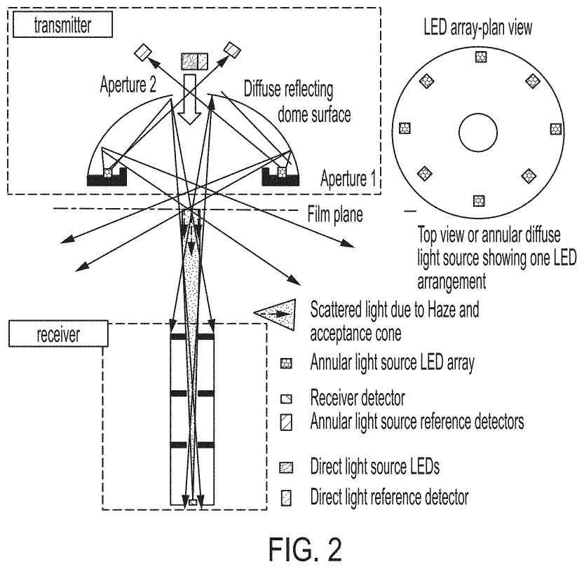

In some embodiments, the optical property measurement system can implement annular diffuse illumination that can illuminate a sample plane over a wide range of angles (e.g., at least 40 degrees around an illumination axis, at least 60 degrees around an illumination axis, at least 70 degrees around an illumination axis, at least 80 degrees around an illumination axis, at least 85 degrees around an illumination axis, or at least at least 90 degrees around an illumination axis) while suppressing the direct and/or near axis illumination (i.e., less than a predetermined amount of degrees (e.g., 5, 2.5, 2) around the illumination axis). Conventionally, such an illumination was generated using a diffusing sphere to provide a controlled illumination at all angles of incidence. In some embodiments, the optical property measurement system can deliver the same except from a truncated diffusing sphere (typically a hemisphere) or other geometries combined with dark field detection with a field of view equivalent to less than or equal to a predetermined amount of degrees. This system can provide the required distribution of illumination intensity at the required angles to replicate the integrating sphere over the range of angles from 1, 2, 2.5, 3, 4, or 5 up to at least 60 degrees, 70 degrees, 80 degrees, or 90 degrees. FIG. 2 illustrates an example of an optical property measurement system described herein.

As shown in FIG. 2, the optical property measurement system can include a transmitter and a receiver. The transmitter can generate a spatially uniform illumination character over a wide angle of incidence at a sample plane (e.g., film plane), that is not in contact with the transmitter, while at the same time suppressing the near normal incidence illumination to create a conical dark field of view in a no sample condition that a narrow field of view receiver can look into. In some embodiments, at a haze level of 0%, no additional light can be scattered into this conical field of view of the detector, and all incident rays of whatever angle continue undeviated and do not reach the detector element. The Field of View of the detector is defined by limiting optical apertures in the optical path to create a narrow angular acceptance cone that the light must enter into to be detected. This angular acceptance cone of the detector is designed to approach the requirement stipulated in ASTM D1003 while the angular annular illumination provides illumination over as wide an angle as practicable while suppressing the near axis illumination that would otherwise directly enter the detector acceptance cone. As haze increases in the sample, the level of light that undergoes scattering and/or deflection into this acceptance cone can increase. Accordingly, the annular angular distribution of light from the diffuse illumination (at least one light source or plurality of light sources) can be scattered by the sample into the narrow acceptance cone of the receiver optics. Under no sample condition, only a very, very small signal (i.e., stray light) can be measured from the diffuse illumination. Stray light can be subtracted out by conventional means, for example, on a scanning/traversing system as a zeroing action when the optical property measurement system (i.e., the transmitter and receiver) are periodically parked off the film sheet or when there is no film present.

In some embodiments, the transmitter can be located above the sample and the receiver can be located below the sample. In some embodiments, the transmitter can be located below the sample and the receiver can be located above the sample. In some embodiments, the transmitter can be located on one side of the sample and the receiver can be located on the other side of the sample. The transmitter can illuminate a sample and the receiver can detect light from the transmitter that has been scattered by a sample. The system can then determine an optical property of the sample based on the scattered light detected.

In some embodiments, the transmitter and the receiver are configured to move in unison along the transverse direction of the film such that an illumination axis between the transmitter and the receiver does not vary more than about 5 degrees, about 2.5 degrees, about 1 degree, or 0.5 degrees. In some embodiments, the illumination axis is perpendicular to the sample plane. In addition, the sample can be spaced apart from the transmitter and the receiver such that it is not in contact with either. As the transmitter and receiver move across the transverse direction of the film, the system can continuously measure the optical property of the film along the transverse direction and the machine direction as the film is being manufactured on the line. This can be beneficial to detect potential issues in the film during manufacturing such that these issues can be corrected before the entire film has been produced.

In some embodiments, the illumination axis between the transmitter and the receiver can stay the exact same and not vary as they both move along the transverse direction of the film. In some embodiments, the transmitter can include a reflector and a direct light source. In some embodiments, the transmitter can be a diffuse reflector such as a truncated spherical diffuse reflector or a planar reflector (further described below). In some embodiments, the reflector can have a first aperture and a second aperture. As shown in FIG. 2, the first aperture can be at the bottom of the reflector or the aperture closer to the sample (e.g., film) and the second aperture can be at the top of the reflector or the aperture farther away from the sample.

The reflector can include at least one light source or a plurality of light sources. In some embodiments, the reflector can include a single light source. The plurality of light sources and the at least one light source can be used interchangeable herein throughout. As such, whenever the term “plurality of light sources” it can be replaced with “at least one light source.” In some embodiments, the plurality of light sources (or single light source) can be LEDs (e.g., white LEDs). In some embodiments, the at least one light source can be adjacent the first aperture of the reflector. In some embodiments, the plurality of light sources can be annularly arranged around an aperture of the reflector. In some embodiments, the light source of the reflector may not be annularly arranged. For example, the plurality of light sources can be a ring of LEDs or other sources placed around an exit aperture of the reflector (e.g., white internal surfaced truncated spherical dome). The plurality of light sources is annularly arranged around the first aperture of the reflector shown in FIG. 2. In addition, FIG. 2 shows an illumination condition that can be generated from a truncated spherical (white) diffuse reflector (Lambertian) that includes an annular/circular array or continuous light source of white light emitters (LEDs) around the circumference of the bottom the reflector and around the first aperture of the reflector. Light from these white light emitters can be emitted upwards toward the reflector to fill the whole inner surface with light. This light can then be scattered and/or reflected from the inner surface of the truncated spherical diffuse reflector over the full 2 pi steradian (180 degrees) scattering angle to create an uniform emission from the exit aperture (aperture 1) over a wide angle.

In some embodiments, the plurality of light sources can be masked to prevent any direct illumination of the detector receiver without any scatter/deviation of the light as a result of interacting with a film placed at the measurement plane. In some embodiments, the first aperture and the second aperture can be configured such that light from the plurality of light sources can be directed at an inner surface of the reflector and reflected out the first aperture towards the sample over a range of angles greater than or equal to a predetermined amount of degrees around the illumination axis. In some embodiments, the predetermined amount of degrees is about 1 degree, about 2 degrees, about 2.5 degrees, about 3 degrees, about 4 degrees, or about 5 degrees. This can broaden the measurement system described herein to cover the options for wider/narrower field of view relative to D1003 (D1003 specification is a geometrical dimensioned specification that reduces to an effective scatter angle of >2.5 degrees). In some embodiments, light from the plurality of light sources can be directed at a white inner surface (e.g., Lambertian diffuser) of a truncated sphere and then reflected/scattered out of the exit aperture of the truncated sphere to provide a wide angle and uniform spatial illumination. In some embodiments, by defining a second aperture of the reflector, the angular content of the emitted light from the plurality of light sources can be defined to reject the near illumination axis light incident at less than a predetermined amount of degrees at the sample plane (e.g., film plane). In some embodiments, this range of angles can be from about 1-90 degrees, about 2-90 degrees, about 2.5-90 degrees, or about 2.5-60 degrees around the illumination axis. For example, the aperture at the top of the reflector can be selected to eliminate near axis angular emission in the area of interest on the measurement plane. In this way, the sample can be illuminated with a very spatially uniform light intensity and with a wide angle distribution of angle of incidence with the exception of the on axis/near axis illumination at up to about a predetermined amount of degrees around the illumination axis.

In addition, the sample can be spaced apart from the first aperture of the reflector. In some embodiments, the reflector can be spaced apart from the sample about greater than or equal to 5 mm to 20 mm to accommodate practical sheet flutter which can be +/−5 mm. In some embodiments, the receiver can be spaced apart from the sample about greater than or equal to 5 mm to 20 mm to accommodate practical sheet flutter which can be +/−5 mm.

Accordingly, to measure the diffuse transmittance of the sample, the sample can be illuminated by the plurality of light sources of the reflector and the receiver can detect light from the plurality of light sources that is scattered by the sample to an angle within a predetermined amount of degrees (e.g., 2.5 degrees) around the illumination axis. The system can then determine the diffuse transmittance of the sample based on the detected scattered light. In some embodiment, the geometry of the reflector can be optimized to suppress the near illumination axis light and provide the required characteristics of the illumination in terms of a uniform spatial illumination and an annular wide angular distribution (e.g., greater than or equal to 60 degrees around the illumination axis).

In some embodiments, the direct light source can be configured to direct light through the second aperture, then through the first aperture, then through a sample to the receiver. In some embodiments, the illumination axis can be a straight/direct axis of light from the direct light source to the receiver that can be perpendicular to the sample plane (e.g., film plane). In some embodiments, the illumination axis can be a straight/direct axis of light from the direct light source to the receiver's at least one detector. In some embodiments, the illumination axis can be the linear axis form the center of the second aperture of the reflector and the detector's center line in the receiver.

In some embodiments, the direct light source can be configured to direct light at less than a predetermined amount of degrees around the illumination axis between the direct light source and the receiver. In some embodiments, the direct light source is configured to direct light directly through the sample onto the detector. To measure the direct transmittance of the sample, the sample can be illuminated by direct light source and the receiver can detect light from the direct light source that has been scattered by the sample into an angular cone of up to +/−a predetermined amount of degrees around the illumination axis. The system can then determine the direct transmittance of the sample based on the detected scattered light. In some embodiments, the light sources can be modulated at high frequencies to improve measurement response time to match the requirements of real time, on-line, where measurements rates of 100 Hz or more are typical.

In some embodiments, the sampling spot size of the receiver can be governed by the overlap of the field of view of the detection cone and the illumination field of view. This can be dominated by the detection field of view because the sample illumination can be vastly oversized to maintain the wide-angle illumination and spatial uniformity of over illumination of the sample measurement detection zone. This can result in high tolerance of the optical property measurement to independent movements of the separate illumination and detection heads typically seen in practical online traversing sensors. The narrow field of view of the receiving optics can be key to the on-line function where alignment of the transmitter is less than 5 degrees, preferably 2.5 degrees around the illumination axis.

In some embodiments, the receiver optical layout can only accept light originating from a virtual source coincident with the top aperture (second aperture) of the diffuse light source. This can define both an angular and a spatial field of view of the receiver at the sample plane. Although the reflector illumination includes wide area illumination, the actual optical property measurement area can be well defined and controlled allowing for improved detail in spatial resolution on a scanning system on a film line. The over illumination at the sample measurement plane can aid improved misalignment tolerance when mounted on a traversing frame on a sheet making plastics line.

As explained above, the plurality of light sources in the reflector can provide a uniform annular wide-angle illumination with no axis/near axis illumination. The plurality of light sources can be driven DC or pulsed to improve signal recovery on the detection. The plurality of light sources can be equipped with their own reference for power monitoring/compensation. In addition, the plurality of light sources can be independently modulated to improve signal recovery. In some embodiments, the transmitter can also include annular light source reference detectors as shown in FIG. 2. These annular light source reference detectors can monitor and/or track the output of the plurality of light sources and can be used to compensate for power fluctuations/aging characteristics, thereby rendering the measurement independent of source variations. The annular light source reference detectors can be illuminated by light from the plurality of light sources that passes through the top second aperture of the reflector.

The direct light source can provide axis/near axis illumination. The direct light source can be equipped with its own reference for power monitoring/compensation. In addition, the direct light source can be individually modulated to improve signal recovery. To allow for losses in signal that arise from mechanisms other than scatter in the forward direction (e.g., absorbances or reflectance (i.e., reflective index changes)), a direct illumination channel can be included. In some embodiments, the transmitter can include a direct light reference detector for intensity/output monitoring and compensation of the direct light source. These other sources of loss in detected signal in the receiver can cause misrepresentation of the haze measurement unless compensated for. As such, by providing a direct illumination path from the direct light source to the receiver, the “missing” cone of light (e.g., light that is less than 2.5 degrees around the illumination axis) deliberately rejected by the diffuse light source (e.g., the plurality of light sources in the reflector), can be recovered. In some embodiments, the illumination arrangement, when combined with a detection arrangement narrow angular detection field of view, can provide a way to detect the level of light scattered into the detection field of view that can be used to measure haze percentage over the range of at least 0.2-20% haze. In some embodiments, the detector can see light that has been deviated by more than 2.5 degrees from its original direction of travel. ASTM D1003 states this requirement for Methods A and B.

In some embodiments, a light source modulation pattern can be via: (1) sequential (time division multiplexing); (2) parallel (demodulation frequency encoding); and (3) quadrature encoding (Phase). The receiver detector may be replaced with an array to allow improved image slicing to further reject stray light. In some embodiments, the haze measurement system can calculate haze according to the equation: H=span×(k0S1/(k1S1+k2S2))+Trim, wherein

S₁— detected signal from annular diffuse illumination (from plurality of light sources)

S₂— detected signal from direct illumination (from direct light source, if present)

K₀, K₁ and K₂— scaling/weighting factors

Span—Global calibration slope

Trim—Global calibration offset

In some embodiments, for some low haze applications, the direct light source can be omitted or K₂ can be set to 0.

As such, the system can determine an optical property of the sample based on the scattered light detected from the plurality of light sources and the direct light source.

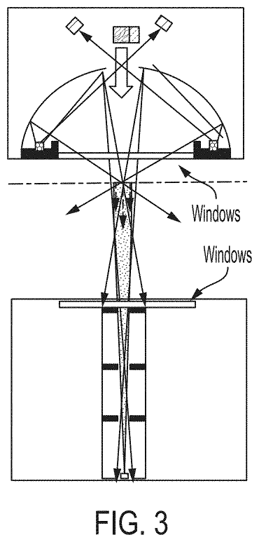

In some embodiments, the optical property measurement system can include windows as shown in FIG. 3. For example, a window can be inserted into the first and/or second aperture. In addition, a window can cover the entrance to the receiver. In some embodiments, these windows are sealed to the reflector and/or receiver device. The addition of windows into the design can provide protection against ingress of dust for a device suitable for industrial operation can add to any residual stray light as the result of dust/contamination that can build up within the area of the windows that coincide with the detection acceptance cone. As described above, the same periodic process of automated zeroing off-sheet or with no sample can take this correction into account. By maintaining a cumulative count of the zeroing correction from an initial “clean” state, the optical property measurement system can provide a direct measure of the build-up of contamination of the windows and can allow for implementation of warning and alarm levels.

In some embodiments, a white reference can be repeatedly introduced over the second aperture to “close” the top aperture of the reflector at known and controlled regular intervals to provide total transmittance instead of or in addition to the direct light source. In some embodiments, the white reference reflector can include a matte diffuse reflector fabricated from, for example, PTFE disk or other white matte materials, such as a painted diffuser. In some embodiments, the white reference reflector can be a recognized diffuse white standard material sintered PTFE (e.g., spectralon or fluorilon) or a white ceramic (e.g, 99.5% alumina). In some embodiments, the white reference reflector does not have to be a 100% reflector. Instead, it can be any level that can be scaled to 100% by a calibration constant.

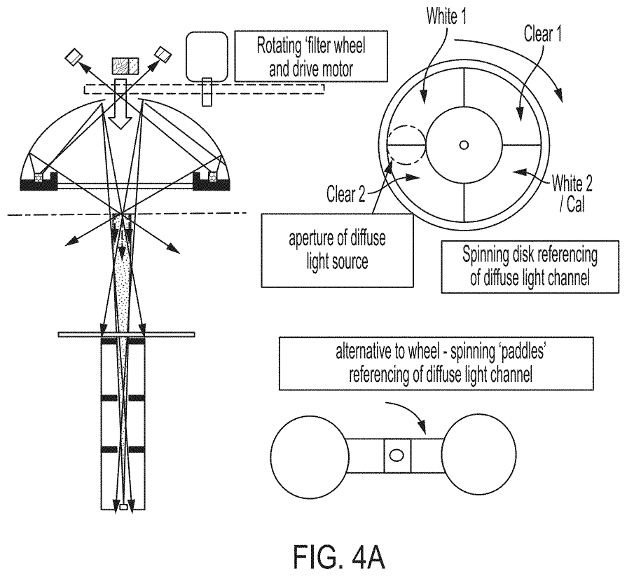

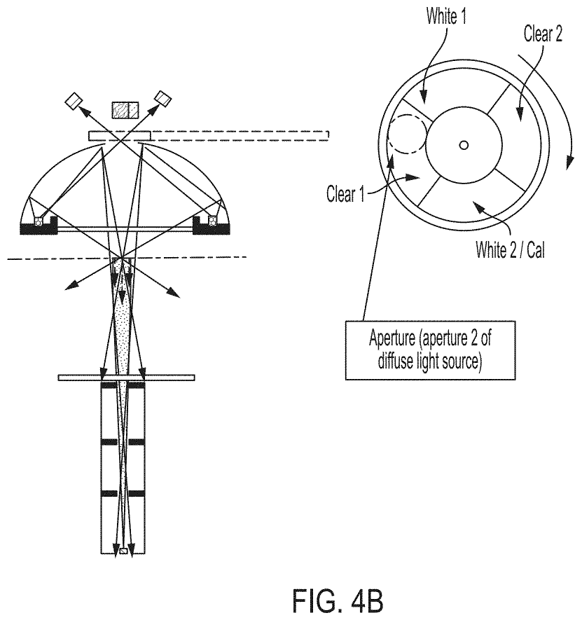

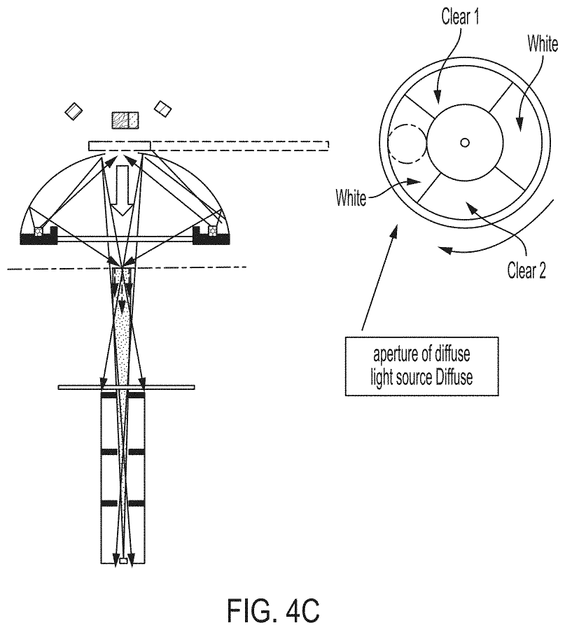

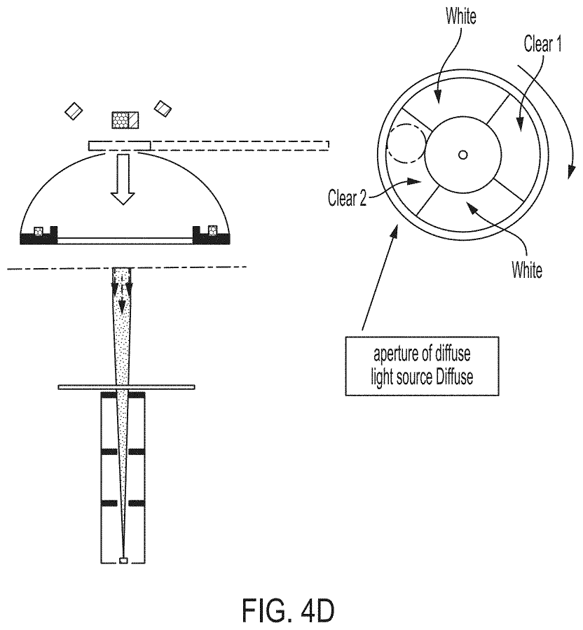

In some embodiments, the transmitter can include a filter that is rotated by a drive motor. The filter can be a filter wheel or a spinning/reciprocating paddle as shown in FIG. 4A. The filter can include at least one white reference reflector. In some embodiments, the filter can be a rotating filter wheel that includes one or more apertures (or apertures occupied with a clear material) and one or more aperture occupied with a white reference reflector. In some embodiments, the filter can be a rotating/spinning filter paddle that includes one or more white reference reflectors. In some embodiments, the filter can be a tuning fork “shutter” or a flipping shutter that can include at least one white reference reflector. The white reference reflector of the filter can be configured to cover the second aperture of the reflector. As such, the at least one white reference reflector of the filter can be controllably inserted/covered and removed from the second aperture of the reflector with the diffuse light source (i.e, plurality of light sources). When there is either no cover over the top second aperture of the reflector or a clear covering over the top second aperture, this can allow for the interleaved/encoded diffuse and direct illumination to be carried out as explained above. When the white reference reflector of the filter is covering/closing the top second aperture of the reflector, the near axis illumination from the diffuse light source that is normally lost out of the top of the reflector is reflected back in to add to the signal seen from scattering produced by the diffuse light source (i.e., plurality of light sources). This can add a second method to measure the total light passing through the sample (e.g., film) to compensate for the variation in reflection and other losses such as absorption and reverse scatter.

Accordingly, the filter can be driven by a motor to give periodic and precisely timed periods for three illumination conditions: (1) diffuse annular illumination; (2) diffuse total illumination; and (3) direct near axis illumination. FIG. 4B illustrates an example of the diffuse annular illumination condition. In this example, the clear portion or empty portion of the filter is over the second aperture of the reflector and the diffuse light source is activated. As such, the diffuse transmittance of the sample can be measured as the sample is illuminated by the plurality of light sources of the reflector and the receiver detects light from the plurality of light sources that is scattered by the sample to an angle of less than a predetermined amount of degrees around the illumination axis. FIG. 4C illustrates an example of diffuse total illumination. In this example, the white reference reflector portion of the filter is over the second aperture of the reflector and the diffuse light source is activated. Light from the plurality of light sources that would normally escape out the second aperture of the reflector can now be redirected back into the reflector and out the first aperture towards the sample. This can provide a measure of the product transmission/scatter under the “full” angle diffuse illumination condition or total transmittance. As such, the diffuse total transmittance of the sample can be measured as the sample is illuminated by the plurality of light sources of the reflector with a white reference reflector covering/closing the second aperture of the reflector and the receiver detects light from the plurality of light sources that is scattered by the sample to an angle of less than a predetermined amount of degrees around the illumination axis.

FIG. 4D provides an example of a direct near axis illumination condition. In this example, the clear portion or empty portion of the filter is over the second aperture of the reflector and the direct light source is activated. As such, the direct transmittance of the sample can be measured as the sample is illuminated by the direct light source and the receiver detects light from the direct light source that has been scattered by the sample to within an angle of up to a predetermined amount of degrees around the illumination axis. Please note that the sequence of FIGS. 4B, 4C, and 4D does not have to be in order and that the diffuse annular and direct lighting conditions can be performed one after the other.

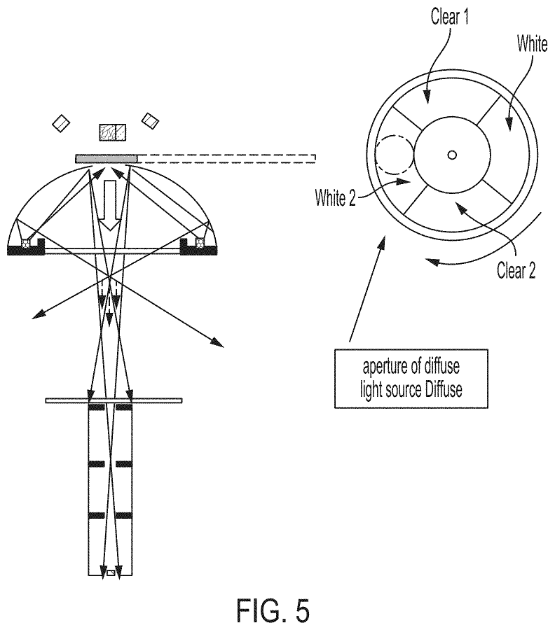

In some embodiments, the filter can also include a translucent white reference reflector (shown as White 2 in the Figures) that can artificially generate a signal representative of low, medium, or high optical property. This can be used to scale the measurement and an additional method to continuously correct for any instability caused by accumulation of dust particles on the windows that may affect the accuracy of the optical property measurement. FIG. 5 shows a fourth lighting condition with a translucent white reference reflector (i.e., a partially diffuse reference reflector) over the second aperture. Here there is no sample/film included. As such, in this off sheet configuration, when the second aperture is uncovered, the detector signal can be near zero when only the plurality of light sources are activated. When the translucent white reference reflectors (e.g., semi-opaque samples) cover the second aperture and the plurality of light sources of the reflector is activated, a representative verification signal that is in the operating range (e.g., 20%) can be created. The signal can be used to verify and/or adjust the scaling of the optical property calculation. In some embodiments, the translucent white reference reflector can be made from a sample of ground glass, plastic, flashed opal, or have a rough metallic surface.

By parking the optical property measurement system in a no sample (e.g., no sheet condition) and running through the illumination conditions (1) diffuse annular illumination; (2) diffuse total illumination; and (3) direct near axis illumination) and the reference standard (using a translucent white reference reflector) cycling sequence with no sample in the gap, a measure of the stray light, the 100% diffuse light condition, and an intermediate diffuse light value (e.g., 20%) can be obtained. These measurements can be combined to correct for offset and scaling of the optical property calculation/calibration. Calibration scaling can operate on the kₙ values of the haze equation described herein. By mounting the reference standards on a continuously operating mechanism such as a spinning wheel, disk, vanes on a motor as shown in FIG. 4 or a reciprocating mechanism such as a linear or rotary solenoid, the compensation can be collected, updated, and continuously applied to real time data.

Although ASTM D1003 uses illuminant C (i.e., blue rich white light), additional separate light sources in the UV, visible (for example, red, green, blue), and NIR spectrum can be used in the optical property measurement system described herein. For example, the plurality of light sources in the reflector can be white light, UV light sources, visible (red, green, blue) light sources, and/or NIR light sources. By including these various light sources in the reflector for diffuse illumination, further insight into the spectral nature of wavelength dependent scatter can be obtained that would not be captured by the single datum form the conventional CIE illuminant C.

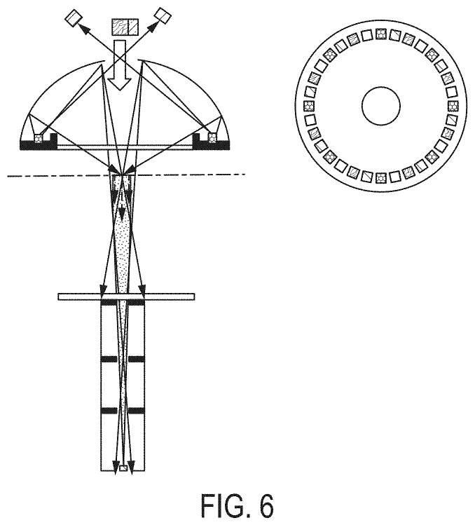

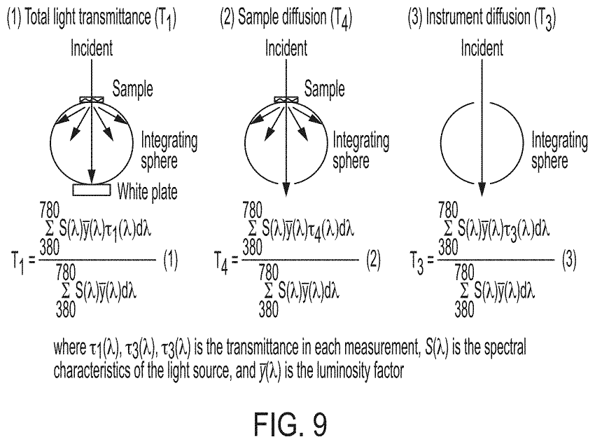

FIG. 6 illustrates an embodiment where the standard white LED array of the plurality of light sources arranged around the first aperture has been replaced with an array of mixed UV, red, green, blue, and/or NIR light sources. By adding separately addressable/selectable one of UV, red, green, blue, and near infrared emitters (light sources) into the diffuse light source reflector, improved tracking of scatter from micro and nanoparticle additives can be facilitated where the scatter characteristic takes on more spectral features (as shown in FIG. 9) such as steeper upwards slope into the blue as the particle size decreases. FIG. 9 illustrates how total transmittance (Tₜ), sample diffusion rate (T₄), and scattering rate (T₃) are obtained using an integrating sphere. The baseline spectrum is obtained using a white diffuse reference plate (1) and the light scattered by the instrument itself is measured (T₃) in order to calibrate the spectrophotometer. The total light transmittance and sample diffusion of the sample is then measured, and the haze value is calculated by the ratio of the two spectra according to the following equation:

$$Haze = \frac{{T}_{d}}{{T}_{t}}$$

In the drive for low haze films, this can provide advantages in the field of nano anti-block additives, whereas white light haze is less sensitive.

In some embodiments, each set of the light sources can be individually addressed and can be pulsed in sequence or other encoding method that can allow the signals arising from each source type to be separated (e.g., Hadamard). As previously stated, using each light source separately to compute haze may not give an improved measurement, but it can give an improved insight into changes in optical properties that D1003 Haze does not accommodate. The D1003 Haze can be measured using the white light sources or through a weighted sum of the contributions from individual spectral components using the following equation: Haze H=span×Σ_{λ=1-n}(k_{0 λ}·S_{1 λ}/(k_{1 λ}·S_{1 λ}+k_{2 λ}·S_{2 λ}))+Trim, wherein:

S_{1 λ}—detected signal from annular diffuse illumination (one light source of the plurality of light sources of wavelength lambda);

S_{2 λ}—detected signal from direct illumination (direct light source (if present) of wavelength lambda);

k_{nλ}—scaling/weighting factors;

Span—global calibration slope;

Trim—Global calibration offset

The typical wavelength regions of interest can be: Red (620-660 nm); Green (520-570 nm); Blue (440-480 nm); UV (200-400 nm); and NIR (750-1000 nm).

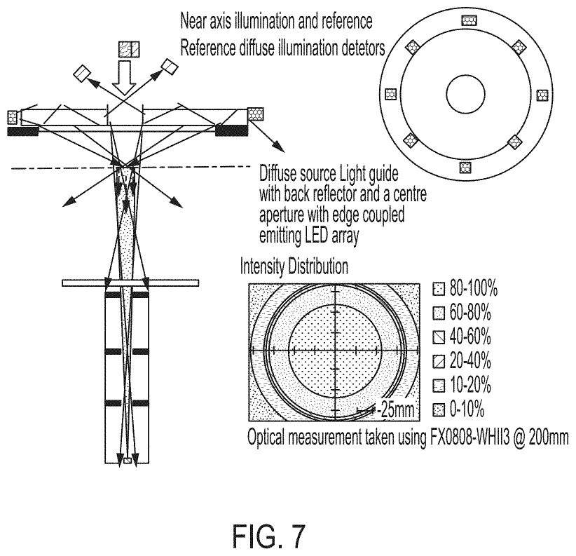

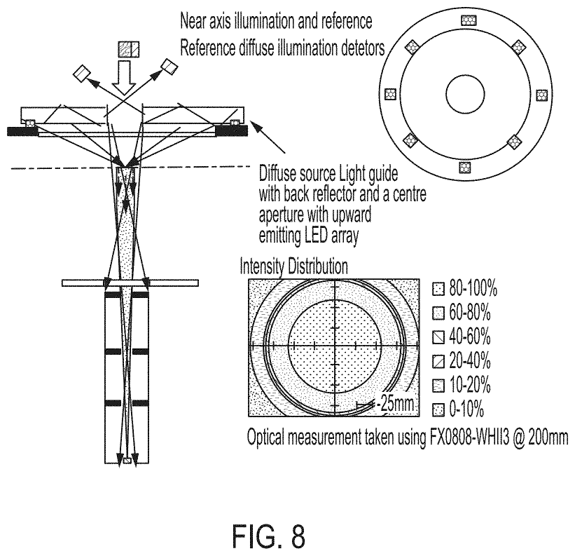

In some embodiments, the reflector is not a truncated spherical reflector. In fact, the truncated spherical reflector can be replaced with an edge lit or backlit planar reflector with a central aperture as shown in FIGS. 7 and 8. This concept can yield the same spatial and angular illumination geometry as the other embodiments disclosed herein. The planar reflector can create/enable a much lower profile diffuse illumination source while at the same time providing the same nature of spatially uniform annular diffuse illumination. An example of such a planar reflector can be found at (https://www.advancedillumination.com/products/fx-series/?generate_spec_sheet=3032), which is hereby incorporated by reference in its entirety.

FIGS. 7 and 8 illustrate the alternative to the truncated spherical reflector which can create the required spatial uniform illumination with an angular pattern. For example, FIG. 7 includes a diffuse source light guide with a back reflector and a center aperture with edge coupled emitting plurality of light sources. FIG. 8 includes a diffuse source light guide with back reflector and a center aperture with upward emitting plurality of light sources.

In some embodiments, light can be injected into the planar reflector (i.e., light guide) at the sides of the reflector (i.e., not the bottom surface as previously described) from a plurality of light sources. This light can then be reflected/scattered out of the first aperture of the reflector by a reflective diffusing/textured upper and a diffusing/textured lower surface of the reflector to yield an uniform spatial distribution as shown in FIGS. 7 and 8. In some embodiments, light can be injected into the planar reflector (i.e., light guide) at the bottom of the reflector from a plurality of light sources annularly spaced apart around the first aperture. Similar to the truncated spherical reflector, the second aperture can perform the near illumination axis angle rejection function. These planar reflectors can be used to replace any of the reflectors disclosed in any of the previous embodiments.

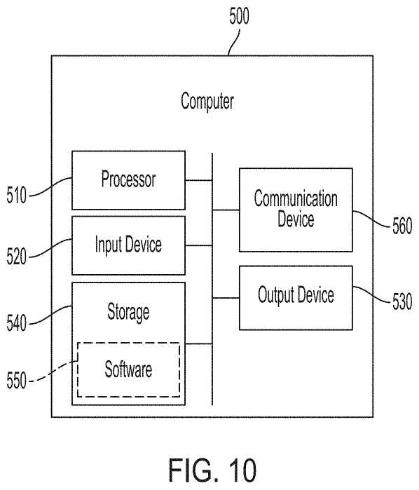

FIG. 10 illustrates a computer, in accordance with some embodiments. Computer 500 can be a component of the optical property measurement system disclosed herein. In some embodiments, computer 500 may be configured to execute a method for measuring the optical property of a sample as disclosed herein including controlling the receiver and/or transmitter of the system.

Computer 500 can be a host computer connected to a network. Computer 500 can be a client computer or a server. As shown in FIG. 5, computer 500 can be any suitable type of microprocessor-based device, such as a personal computer; workstation; server; or handheld computing device, such as a phone or tablet. The computer can include, for example, one or more of processor 510, input device 520, output device 530, storage 540, and communication device 560.

Input device 520 can be any suitable device that provides input, such as a touch screen or monitor, keyboard, mouse, or voice-recognition device. Output device 530 can be any suitable device that provides output, such as a touch screen, monitor, printer, disk drive, or speaker.

Storage 540 can be any suitable device that provides storage, such as an electrical, magnetic, or optical memory, including a RAM, cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein, such as all or part of the optical property measurement methods explained above.

Software 550, which can be stored in storage 540 and executed by processor 510, can include, for example, the programming that embodies the functionality of the present disclosure (e.g., as embodied in the systems, computers, servers, and/or devices as described above). In some embodiments, software 550 can be implemented and executed on a combination of servers such as application servers and database servers.

Software 550 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that a layer has a thickness of at least about 5 cm, about 10 cm, or about 15 cm is meant to mean that the layer has a thickness of at least about 5 cm, at least about 10 cm, or at least about 15 cm.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

What is claimed is:

1. An optical property measurement system comprising:
a transmitter, the transmitter comprising:
a diffuse reflector comprising a first aperture and a second aperture;
a direct light source configured to direct light through the second aperture and first aperture toward a sample spaced apart from the first aperture at less than a predetermined amount of degrees around an illumination axis between the direct light source and a receiver,
wherein the diffuse reflector comprises at least one light source adjacent the first aperture and configured to direct light at an inner surface of the diffuse reflector such that it is reflected out the first aperture towards the sample over a range of angles greater than or equal to the predetermined amount of degrees around the illumination axis; and
the receiver configured to detect light from the direct light source and the at least one light source that is scattered by the sample to an angle of less than the predetermined amount of degrees around the illumination axis, wherein the system is configured to determine an optical property of the sample based on the scattered light detected from the at least one light source and the direct light source.

2. The system of claim 1, wherein the diffuse reflector has a truncated spherical shape or a planar shape.

3. The system of claim 1, wherein the predetermined amount of degrees is 2.5 degrees.

4. The system of claim 1, wherein the transmitter is located on one side of the sample and the receiver is located on the other side of the sample.

5. The system of claim 1, wherein the sample is a film, and the transmitter and the receiver are configured to move in unison across the transverse direction of the film.

6. The system of claim 1, further comprising a filter comprising at least one white reference reflector.

7. The system of claim 6, wherein the filter is configured to cover the second aperture of the reflector with the at least one white reference reflector.

8. The system of claim 7, further comprising a motor configured to rotate the filter such that the at least one white reference reflector covers and uncovers the second aperture of the reflector.

9. The system of claim 6, wherein the filter comprises a translucent white reference reflector.

10. The system of claim 1, wherein the at least one light source comprise at least one of a white light source, a UV light source, a red light source, a green light source, a blue light source, and an infrared light source.

11. The system of claim 1, wherein the sample is spaced apart from the first aperture by at least 5 mm.

12. A method of measuring an optical property of a sample, comprising:
illuminating a sample via at least one light source, wherein the at least one light source is adjacent a first aperture of a diffuse reflector and configured to direct light at an inner surface of the diffuse reflector such that it is reflected out the first aperture towards the sample over a range of angles greater than or equal to a predetermined amount of degrees around an illumination axis between a direct light source and a receiver;
detecting light from the at least one light source that is scattered by the sample to an angle of less than the predetermined amount of degrees around the illumination axis;
illuminating a sample via the direct light source configured to direct light through a second aperture of the truncated spherical diffuse reflector and through the first aperture at less than the predetermined amount of degrees around the illumination axis; and
detecting light from the direct light source that is scattered by the sample to an angle of less than the predetermined amount of degrees around the illumination axis; and
determining an optical property of the sample based on the scattered light detected from the at least one light source and the direct light source,
wherein the sample is spaced apart from the first aperture.

13. The method of claim 12, further comprising covering the second aperture with a filter comprising a white reference reflector.

14. The method of claim 13, wherein when the second aperture is covered by the filter, the at least one light source directs light at an inner surface of the diffuse reflector and the white reference reflector such that it is reflected out the first aperture towards the sample over a range of angles greater than or equal to 0 degrees around the illumination axis.

15. The method of claim 12, wherein the diffuse reflector has a truncated spherical shape or a planar shape.

16. The method of claim 12, wherein the predetermined amount of degrees is 2.5 degrees.

17. The method of claim 12, wherein the transmitter is located above the sample and the receiver is located below the sample.

18. The method of claim 12, wherein the sample is a film, and the transmitter and the receiver are configured to move in unison across the transverse direction of the film.

19. The method of claim 12, wherein the at least one light source comprises at least one of a white light source, a UV light source, a red light source, a green light source, a blue light source, and a near infrared light source.

20. The method of claim 12, wherein the sample is spaced apart from the first aperture by at least 5 mm.
